(19) United States
(12) Patent Application Publication
(10) Pub. No.: US 2023/0418894 A1
(43) Pub. Date: Dec. 28, 2023

(54) INPUT METHOD AND APPARATUS BASED ON SAMPLE-PROBABILITY QUANTIZATION, AND ELECTRONIC DEVICE

(71) Applicant: GUANGZHOU ZIIPIN NETWORK TECHNOLOGY CO., LTD., Guangzhou, Guangdong (CN)

(72) Inventor: Zhenxing LIANG, Guangzhou, Guangdong (CN)

(21) Appl. No.: 18/253,707

(22) PCT Filed: Apr. 25, 2022
(86) PCT No.: PCT/CN2022/088927

§ 371 Date: May 19, 2023

(30) Foreign Application Priority Data
Apr. 27, 2021 (CN) 202110461788.6
Apr. 27, 2021 (CN) 2021104617886

(51) Int. Cl. G06F 17/12; G06F 7/499

(52) U.S. Cl. CPC G06F 17/12; G06F 7/49947

(57) ABSTRACT

The method includes acquiring a user-input information, and calculating to obtain candidate words; performing probability predicting calculation to the candidate words, to obtain probability values of the candidate words; inputting the probability values of the candidate words into a mapping function, to obtain probability mapping values corresponding to the candidate words, wherein the mapping function is configured for mapping the probability values into a specified range of probability mapping values, and within the specified range, adjusting a statistical dispersion of the probability mapping values into an expectation, wherein the probability values and the probability mapping values are bijective; performing rounding processing to the probability mapping values, to obtain quantized probability mapping values; and according to the quantized probability mapping values, determining an order of the candidate words, to output a list of candidate words in order. This disclosure reduces the degree of distortion of the probability values after the quantization.

### TECHNICAL FIELD

The present disclosure relates to the technical field of natural language processing, and particularly relates to an input method and apparatus based on sample-probability quantization, and an electronic device.

### BACKGROUND

Technology is the motive power of social development. Currently, the Ngram language model can be trained by a large amount of corpus, and has already been able to provide an excellent experience in input words for the users of most common languages, for example, English, French and so on. However, regarding the relevant languages of the countries and regions involved in the Belt and Road Initiative, for example, Arabic, Turkish and so on, because of the characteristics of their language with huge vocabularies, as compared with English and so on, they have a more serious long tail effect, and common techniques of natural language processing have difficulty in the processing of the huge quantity of words in the part of long tail, which results in that the users in the countries and regions involved in the Belt and Road Initiative cannot obtain a good experience in input words.

Particularly, currently, in some of the language models (for example, ELMo, BERT, GPT-2 and so on) in the field of NLP (Natural Language Processing), by collecting a large amount of corpus to feed into a neural network of a language model, and performing machine learning, the finally produced system can predict the user's input words. In the prediction, the language model, according to the word frequency data (including the phrase context and the word-sample frequency) and so on, can generate the probability values of the candidate words, and the system, by analyzing the probability values of the candidate words, obtains the list of candidate words that is finally displayed to the user.

In a mobile device environment, because of the limitation of the data storage space, the probability values are required to be quantitively stored, i.e., mapping the probability values from the real number range to the integer range, and then performing calculating and processing. Based on the different mapping methods, the probability values will have distortion to different extents. Therefore, it is required to provide an ideal mapping method, which can reduce the degree of distortion of the probability values after the quantization to the largest extent, which enables the order of the candidate words in list determined based on the probability values after the quantization to maintain consistent with that before the quantization to the largest extent. That can facilitate to improve the techniques of natural language processing, especially by increasing the quantity of the candidate words at the part of long tail, and improve the accuracy of the prediction of the candidate words. Accordingly, the countries and regions involved in the Belt and Road Initiative, by applying the novel inventive technique, can also obtain an excellent experience in input words, which truly and actually improves people's life by technology.

### SUMMARY

An embodiment of the present disclosure provides an input method based on sample-probability quantization, which can reduce the degree of distortion of the probability values after the quantization, which enables the order of the candidate words in list determined based on the probability values after the quantization to maintain consistent with that before the quantization to the largest extent.

Correspondingly, the embodiments of the present disclosure further provide an input apparatus based on sample-probability quantization and an electronic device, to ensure the implementation and application of the method stated above.

In order to solve the above problems, an embodiment of the present disclosure provides an input method based on sample-probability quantization, wherein the method comprises:
acquiring a user-input information, and calculating to obtain candidate words;
performing probability predicting calculation to the candidate words, to obtain probability values of the candidate words;
inputting the probability values of the candidate words into a mapping function, to obtain probability mapping values corresponding to the candidate words, wherein the mapping function is configured for mapping the probability values into a specified range of probability mapping values, and within the specified range, adjusting a statistical dispersion of the probability mapping values into an expectation, wherein the probability values and the probability mapping values are bijective;
performing rounding processing to the probability mapping values, to obtain quantized probability mapping values; and
according to the quantized probability mapping values, determining an order of the candidate words, to output a list of candidate words in order.

Optionally, before the step of performing probability predicting calculation to the candidate words, to obtain the probability values of the candidate words, the method further comprises:
collecting and summarizing candidate-word sample data, and counting up to obtain a sample-type quantity of candidate-word samples;
performing statistical analysis to the candidate-word samples, to obtain sample probability values of the candidate-word samples, and then, according to a figure of distribution of the sample probability values, calculating to obtain a distribution width and a distribution center;
acquiring a data-storage-space information of an electronic device, and calculating to obtain the specified range of probability mapping values and a range boundary; and
according to the sample-type quantity, the distribution width, the distribution center, the specified range of probability mapping values and the range boundary, generating the mapping function and a quantization function.

Optionally, the method further comprises:
according to the distribution width, the specified range of probability mapping values and the range boundary, generating a condition mapping function.

Optionally, the mapping function comprises a piecewise mapping function defined by multiple sub-functions, wherein each of the sub-functions applies to a different interval in a domain of the mapping function, and the step of inputting the probability values of the candidate words into the mapping function, to obtain the probability mapping values corresponding to the candidate words comprises:
determining an interval that the probability values of the candidate words fall within, to acquire a corresponding sub-function as a specific mapping function applies to the interval; and
inputting the probability values of the candidate words into the specific mapping function, to obtain the probability mapping values corresponding to the candidate words, wherein the specific mapping function is configured for mapping the probability values on the interval into a specific range of the probability mapping values, wherein the specific range is a part of the whole range of the mapping function.

Optionally, the method further comprises:
acquiring word classes corresponding to the candidate words;
performing probability predicting calculation to the word classes, to obtain probability-of-condition values of the word classes;
under a condition of the word classes, performing probability predicting calculation to the candidate words, to obtain conditional-probability values of the candidate words;
inputting the probability-of-condition values of the word classes into the condition
mapping function, to obtain probability-of-condition mapping values corresponding to the word classes;
inputting the conditional-probability values of the candidate words into the mapping function, to obtain conditional-probability mapping values corresponding to the candidate words; and
firstly performing accumulating calculation and then performing rounding processing, or firstly performing rounding processing and then performing accumulating calculation, to the probability-of-condition mapping values and the conditional-probability mapping values, to obtain the quantized probability mapping values of the candidate words.

Optionally, the mapping function ƒ(x) is:

$$f ( x ) = \{ \begin{matrix}{G}_{0} + \frac{g ( x ) - {G}_{0}}{g ( 0 ) - {G}_{0}} \cdot ( W - 1 - {G}_{0} ) , 0 \leq x < {A}^{- 1} \cdot {p}_{0} \\ g ( x ) , {A}^{- 1} \cdot {p}_{0} \leq x \leq A \cdot {p}_{0} \\ {G}_{1} + \frac{g ( x ) - {G}_{1}}{g ( 1 ) - {G}_{1}} \cdot ( 1 - {G}_{1} ) , A \cdot {p}_{0} < x \leq 1\end{matrix}$$

$$wherein h ( x ) = ln ( x \cdot {K}^{{t}_{k}} + 1 ) , and g ( x ) = ( h ( {p}_{0} ) - h ( x ) ) \cdot L + \frac{W}{2} ,$$

$$L = \frac{W - 2 {W}_{E}}{2 \cdot ln ( A )} , {G}_{0} = g ( {A}^{- 1} \cdot {p}_{0} ) , {G}_{1} = g ( A \cdot {p}_{0} )$$

wherein tₖ is a dispersion exponent of a distribution of the probability mapping values, K is the sample-type quantity, A is the distribution width, p₀ is the distribution center, W is an upper bound of the specified range of probability mapping values, and W_{E} is the range boundary;

wherein a formula of tₖ is one of:

$${t}_{k} = \frac{\frac{W - 2}{2 L} + ln ( {p}_{0}^{- 1} )}{l n ( K )}$$

$${t}_{k} = \frac{ln ( A ) + ln ( {p}_{0}^{- 1} ) + D}{ln ( K )}$$

$${t}_{k} = \frac{ln ( {p}_{min}^{- 1} ) + D}{ln ( K )}$$

wherein D is a precision adjustment parameter.

Optionally, the condition mapping function ƒₘ(m) is:

ƒₘ(m)=ln(m⁻¹)·L

wherein m is the probability-of-condition value.

The embodiments of the present disclosure further provide an input apparatus based on
sample-probability quantization, wherein the apparatus comprises:
an input module configured for acquiring a user-input information;
a candidate-word module configured for, according to the user-input information,
calculating to obtain candidate words;
a sampling module configured for collecting and summarizing candidate-word sample data;
a device-information module configured for acquiring a data-storage-space information of an electronic device;
a parameter module configured for, according to the candidate-word sample data, and the data-storage-space information of the electronic device, calculating to obtain a sample-type quantity, a distribution width, a distribution center, a specified range of probability mapping values and a range boundary, and generating a mapping function, a condition mapping function and a quantization function;
a probability predicting module configured for performing probability predicting calculation to the candidate words, to obtain probability values of the candidate words; and further configured for acquiring word classes corresponding to the candidate words, and under a condition of the word classes, performing probability predicting calculation to the candidate words, to obtain conditional-probability values of the candidate words;
a probability-of-condition predicting module configured for performing probability predicting calculation to the word classes, to obtain probability-of-condition values of the word classes;
a mapping module configured for inputting the probability values or the conditional-probability values of the candidate words into the mapping function, to obtain probability mapping values or conditional-probability mapping values corresponding to the candidate words, wherein the mapping function is configured for mapping the probability values or the conditional-probability values into a specified range of probability mapping values, and within the specified range, adjusting a statistical dispersion of the probability mapping values or the conditional-probability mapping values into an expectation, wherein the probability values and the probability mapping values are bijective, and the conditional-probability values and the conditional-probability mapping values are bijective;
a condition mapping module configured for inputting the probability-of-condition values of the word classes into the condition mapping function, to obtain probability-of-condition mapping values corresponding to the word classes;
a condition quantizing module configured for performing rounding processing to the probability-of-condition mapping values, to obtain quantized probability-of-condition mapping values;
a quantizing module configured for performing rounding processing to the probability mapping values, to obtain quantized probability mapping values; and further configured for firstly performing accumulating calculation and then performing rounding processing to the probability-of-condition mapping values and the conditional-probability mapping values, or firstly performing rounding processing to the conditional-probability mapping values and then performing accumulating calculation with the quantized probability-of-condition mapping values, to obtain the quantized probability mapping values of the candidate words; and
an output module configured for, according to the quantized probability mapping values, determining an order of the candidate words, to output a list of candidate words in order.

An embodiment of the present disclosure further provides an electronic device, wherein the electronic device comprises a memory, and one or more programs, wherein the one or more programs are stored in the memory, and the one or more programs are configured for being executed by one or more processors to implement the input method based on sample-probability quantization stated above.

An embodiment of the present disclosure further provides a readable storage medium, wherein when an instruction in the storage medium is executed by a processor of an electronic device, the electronic device is able to implement the input method based on sample-probability quantization stated above.

The embodiments of the present disclosure have the following advantages:

The embodiments of the present disclosure acquire a user-input information, calculate to obtain candidate words, perform probability predicting calculation to the candidate words, to obtain the probability values of the candidate words, then input the probability values of the candidate words into a mapping function, to obtain probability mapping values corresponding to the candidate words, then perform rounding processing to the probability mapping values, to obtain quantized probability mapping values, then according to the quantized probability mapping values, determine the order of the candidate words, and finally output a list of candidate words in order. The embodiments of the present disclosure, by using the mapping function, can map the probability values into the specified range of probability mapping values, and, by using the mapping function, can adjust the statistical dispersion of the probability mapping values into an expectation, which can reduce the degree of distortion of the probability values after the quantization to the largest extent, which enables the order of the candidate words in list determined based on the probability values after the quantization to maintain consistent with that before the quantization to the largest extent.

In addition, by using the mapping function, the probability values and the probability mapping values can always be bijective, and, because even probability mapping values obtained by calculation from different electronic devices are based on the same one mapping method, the different probability mapping values are comparable and sortable, which enables the method of the candidate words recommendation to be generalized and standardized, thereby facilitating subsequent development and expansion.

### BRIEF DESCRIPTION OF THE DRAWINGS

FIG. 1 is a flow chart of the steps of an embodiment of the method for generating the mapping function and the quantization function used for sample-probability quantization according to the present disclosure;

FIG. 2 is a flow chart of the steps of a first embodiment of the input method based on sample-probability quantization according to the present disclosure;

FIG. 3 is a flow chart of the steps of a second embodiment of the input method based on sample-probability quantization according to the present disclosure; and

FIG. 4 is a structural block diagram of an embodiment of the input apparatus based on sample-probability quantization according to the present disclosure.

### DETAILED DESCRIPTION

In order to make the above purposes, features and advantages of the present disclosure more apparent and understandable, the present disclosure will be described in further detail below with reference to the drawings and the particular embodiments.

In order to enable a person skilled in the art to better understand the embodiments of the present disclosure, some involved technical terms will be explained below:

Sample: is a statistical term, and refers to individuals that are randomly extracted from the totality. By investigating the samples, the profile of the totality can be generally known. In sampling, samples are extracted for the investigation, while, in census, it is required to investigate each of the individuals in the totality.

Probability: is also referred to as odds, opportunity or probability, is a basic concept of mathematical probability theory, is a real number between 0 to 1, and is a measurement of the possibility of the occurrence of a random event.

Sample Probability: refers to the probability of the random extraction of a certain type of particular sample in the sampling process. In the present disclosure, it is also referred to probability of a word event on sample space.

Probability Distribution: is referred to for short as distribution, and is a concept in the mathematical probability theory. In a board sense, it refers to the probabilistic nature of random variables, and, in a narrow sense, it refers to the probability distribution function of random variables.

Normalization: is a mode for simplifying calculation, and refers to transforming a dimensional expression into a dimensionless expression, to become a scalar quantity.

Standard Deviation (SD): is also referred to as standard error or mean squared error, and is most commonly used for measuring the statistical dispersion of a group of numerical values in probability statistics.

In some environments, for example, in an electronic device at the mobile side, because of the limitation by the data storage space, it is required to perform quantitative storage to the probability values obtained from a language model, i.e., mapping from the real number field to the integer field, and then performing calculating and processing. Based on the different mapping methods, the probability values will have distortion to different extents. Therefore, an ideal mapping method is required, to enable the integer values (quantized probability mapping values) obtained after the mapping of different probability values to have a large degree of distinction. In other words, the integer values obtained after the mapping of the probability values should have a discrete distribution to the largest extent (the coverage rate of the value-domain range should exceed 80%).

The mapping method may refer to the normalization methods, to map the probability values from a real-number range to another real-number range. Regarding a probability value that belongs to the real number field, after the mapping, a probability mapping value that belongs to the real number field is obtained, and then it is rounded to obtain a quantized probability mapping value that belongs to the integer field. The result is the desired quantization result of the probability values of the samples.

Methods of normalization currently commonly used include min-max normalization, z-score normalization, decimal scaling normalization and so on. However, those normalization methods have some problems. Particularly:
1. They cannot map specific probability-values range into specific probability-mapping-values range;
2. They cannot adjust the statistical dispersion (standard deviation) of the probability mapping values by using parameters; and
3. The probability mapping values of different groups are not comparable. The probability mapping value of each single probability value depends on the numerical distribution of which group the probability value belongs to. Therefore, in the different groups, even the same one probability value obtains probability mapping values that are not completely the same. In other words, the probability values and the probability mapping values of different groups cannot always be bijective. If the probability values of different groups are combined, and are arranged in order according to the probability mapping values, that cannot ensure that the corresponding probability values are arranged in order.

Aiming at the above problems, the embodiments of the present disclosure provide a novel normalization method (logarithm normalization), which maps the probability-values range from a real-number range to another real-number range. The method according to the embodiments of the present disclosure, by using some parameterized mapping functions and quantization functions, maps the probability values from real-number values to obtain probability mapping values, and then rounds to become integer values (quantized probability mapping values), whereby one probability value can correspond to one quantized probability mapping value, to form quantized data of integer datatype. The embodiments of the present disclosure can reduce the degree of distortion of the probability values after the quantization, which enables the order of the list of candidate words determined based on the probability values after the quantization to maintain consistent with that before the quantization to the largest extent.

In addition, as compared with the methods of normalization currently commonly used, the embodiments of the present disclosure can solve the following problems:
1. To map specific probability-values range into specific probability-mapping-values range;
2. To adjust the statistical dispersion (standard deviation) of the probability mapping values by using parameters; and
3. The probability mapping values of different groups are comparable and sortable.

The embodiments of the present disclosure will be described in detail below.

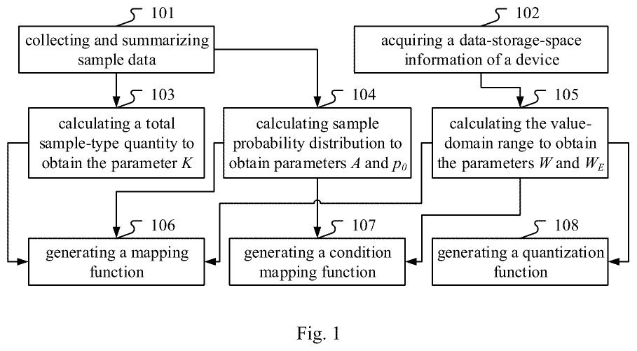

Referring to FIG. 1, FIG. 1 shows a flow chart of the steps of an embodiment of the method for generating the mapping function and the quantization function used for sample-probability quantization according to the present disclosure, which may particularly comprise the following steps:

Step 101: collecting and summarizing candidate-word sample data.

The collected candidate-word samples may be acquired from books, articles or webpage contents, and may also be acquired from candidate words generated from a user-input information.

Particularly, the contents of all of article paragraphs contain relatively complete phrase context information, and are relatively ideal source of corpus data. Moreover, in some regions where current written literal data are scarce, the candidate words generated by users may be collected anonymously, to establish the user corpus data.

Step 102: acquiring a data-storage-space information of an electronic device.

Step 103: according to the candidate-word sample data, and counting up to obtain a sample-type quantity of candidate-word samples.

According to the sample-type quantity, the parameter K of a mapping function may be set.

Particularly, each of the samples has the type that it belongs to; for example, the gender types of human being are man and woman, so the type quantity is 2. The samples used in the input method according to the embodiments of the present disclosure are words collected from various regions, the type that they belong to is vocabulary, and the type quantity is the word quantity. As an example, in the region of Egypt, the collected word quantity (type quantity) is approximately 14235, and therefore the type quantity of the region of Egypt may be directly used for setting the parameters of the mapping function as K=14235.

Step 104: according to the candidate-word sample data, performing statistical analysis to the candidate-word samples, to obtain sample probability values of the candidate-word samples, and then, according to a figure of distribution of the sample probability values, calculating to obtain a distribution width and a distribution center.

Step 105: according to the data-storage-space information of the electronic device, calculating to obtain the specified range of probability mapping values and a range boundary.

According to the data-storage-space information of the electronic device, the parameter W of the mapping function may be set.

Particularly, each of electronic devices has its corresponding data-unit types, to enable data to be quantized and stored in the electronic device. The data-unit types may be acquired from the data-storage-space information, and each of the data-unit types has its upper bound. Regarding a positive-integer type, determining its upper bound is equivalent to determining its numerical-value range. For example, the data-unit types of an electronic device may be data types such as uint8 and uint16. The range of the data type of positive integer uint8 is 0-255, and the upper bound is 255. The range of the data type of positive integer uint16 is 0-65535, and the upper bound is 65535. If the data-unit type of the electronic device is the data type uint8, then the parameter W of the mapping function is set to be W=256, which indicates that its range of probability mapping values is 0-255. If the data-unit type of the electronic device is the data type uint16, then the parameter W of the mapping function is set to be W=65535, which indicates that its range of probability mapping values is 0-65535.

According to the range of probability mapping values, the parameter W_{E} of the mapping function may be set, i.e., the specific probability-mapping-values range boundary. In addition, according to the figure of distribution of the sample probability values of the candidate-word samples, the parameter A and the parameter p₀ of the mapping function may be set, i.e., the distribution width and the distribution center.

The parameter W_{E} may be considered as the specific range of probability mapping values itself, and the magnitude of its numerical value indirectly affects the statistical dispersion (standard deviation) of the probability mapping values. The parameter A may be considered as the width of the discretized distribution, and the magnitude of its numerical value directly affects the statistical dispersion (standard deviation) of the probability mapping values. The parameter p₀ may be considered as the center of the discretized distribution, and the magnitude of its numerical value indirectly affects the statistical dispersion (standard deviation) of the probability mapping values.

Particularly, according to actual demands, different parameters W_{E} may be set. For example, when W=256, the parameter W_{E} may be set to be W_{E}=20. The parameter A and the parameter p₀ may be considered as the width and the central value of a normal distribution, and by adjusting those two parameters, the form of the normal distribution of the probability mapping values in the specified range of probability mapping values [1, W−1] may be adjusted. Optionally, numerical analysis is firstly performed to the figure of distribution of the sample probability values, and then value estimation is performed to the parameter A and the parameter p₀. For example, it may be set that the parameter A=256, and the parameter p₀=1/K.

Step 106: according to the sample-type quantity, the distribution width, the distribution center, the specified range of probability mapping values and the range boundary, generating a mapping function.

Step 107: according to the distribution width, the specified range of probability mapping values and the range boundary, generating a condition mapping function.

Step 108: according to the specified range of probability mapping values and the range boundary, generating a quantization function.

An embodiment of the method for generating the mapping function and the quantization function used for sample-probability quantization according to the present disclosure has been described above. A first embodiment of the input method based on sample-probability quantization according to the present disclosure will be described below.

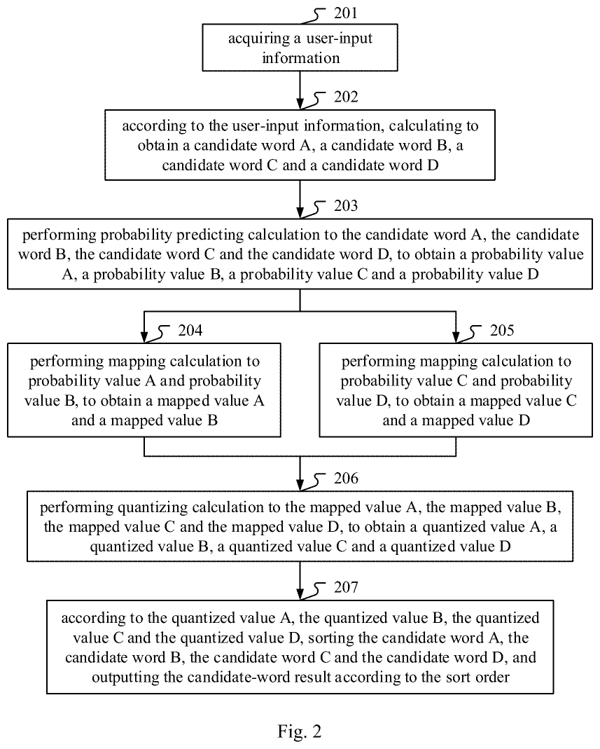

Referring to FIG. 2, FIG. 2 shows a flow chart of the steps of a first embodiment of the input method based on sample-probability quantization according to the present disclosure, which may particularly comprise the following steps:

Step 201: acquiring a user-input information.

The embodiments of the present disclosure may be applied to electronic devices such as a mobile terminal, a television set, a computer and a palmtop. In the process when a user is using an input-method program (hereinafter referred to as an input method) on an electronic device, the input information of the user may be acquired. Particularly, the input information may be the information that is inputted by the user when invoking the input method in other application programs to perform the inputting process. The other application programs may refer to other application programs than the input method, such as a chatting application program and a game application program, which is not limited in the embodiments of the present disclosure.

Step 202: according to the user-input information, calculating to obtain candidate words.

Step 203: performing probability predicting calculation to the candidate words, to obtain probability values of the candidate words.

The input information on the input method by the user may be inputted into a language model that has been trained in advance to perform predicting calculation, thereby obtaining the candidate words that match with the input information and the probability values corresponding to the candidate words.

Step 204: inputting the probability values of some of the candidate words into a mapping function, to obtain the probability mapping values corresponding to some of the candidate words.

Step 205: inputting the probability values of the other candidate words into the mapping function, to obtain the probability mapping values corresponding to the some of the candidate words.

The mapping function ƒ(x) is a mapping function configured according to corpus samples of regions, electronic devices and other demand responses. The mapping function may be obtained from, for example, the mapping-function generating method of the step 106, and may also be obtained from other mapping-function generating methods. For example, regarding a mapping function from the region of Egypt, the parameters of the mapping function may be adjusted by collecting the corpus samples in the region of Egypt. As another example, regarding an electronic device using the data type uint8, the parameters of the mapping function may be adjusted based on the data type.

After the probability values of the candidate words have been acquired, by using the mapping function, the probability mapping values corresponding to the probability values of the candidate words are obtained by mapping. By using the mapping function, the probability values can be mapped into the specified range of probability mapping values, and the statistical dispersion of the probability mapping values can be adjusted into an expectation, wherein the probability values and the probability mapping values are bijective.

It can be seen that the step 204 and the step 205 are two similar steps. Their function is that they group several candidate words, and separately calculate the probability values of each of the groups, wherein the calculation processes of each of the groups may be independent and asynchronous. The probability mapping values obtained after the calculation of each of the groups may be summarized to the next step for collective processing. That means that, no matter how the candidate words are grouped, and no matter how the order between the calculations of each of the groups is determined, the result of the probability mapping values obtained by calculation is not changed. That provides support for the high concurrency of the process of mapping calculation.

Step 206: performing rounding processing to the probability mapping values, to obtain quantized probability mapping values.

The quantization function may be obtained from, for example, the quantization-function generating method of the step 108, and may also be obtained from other quantization-function generating methods.

Step 207: according to the quantized probability mapping values, determining an order of the candidate words, to output a list of candidate words in order.

The embodiments of the present disclosure may comprise, after the probability mapping values corresponding to the probability values have been obtained, performing rounding processing to the probability mapping values, to obtain quantized probability mapping values as integers, then determining the order of the candidate words based on the quantized probability mapping values, then sorting all of the candidate words in order, to obtain the order of the list of candidate words, and, finally, in order, exhibiting the candidate words with higher ranks as the candidate-word result on the input method of the electronic device. For example, the candidate words with the 5 highest ranks in the order are exhibited as the candidate-word result on the input method.

The embodiments of the present disclosure acquire a user-input information, calculate to obtain candidate words, perform probability predicting calculation to the candidate words, to obtain the probability values of the candidate words, then input the probability values of the candidate words into a mapping function, to obtain probability mapping values corresponding to the candidate words, then perform rounding processing to the probability mapping values, to obtain quantized probability mapping values, then according to the quantized probability mapping values, determine the order of the candidate words, and finally output a list of candidate words in order. The embodiments of the present disclosure, by using the mapping function, can map the probability values into the specified range of probability mapping values, and, by using the mapping function, can adjust the statistical dispersion of the probability mapping values into an expectation, which can reduce the degree of distortion of the probability values after the quantization to the largest extent, which enables the order of the list of candidate words determined based on the probability values after the quantization to maintain consistent with that before the quantization to the largest extent. In addition, by using the mapping function, the probability values and the probability mapping values can always be bijective, and, because even probability mapping values obtained by calculation from different electronic devices are based on the same one mapping method, the different probability mapping values are comparable and sortable, which enables the method of the candidate words recommendation to be generalized and standardized, thereby facilitating subsequent development and expansion.

In an exemplary embodiment, the mapping function comprises a piecewise mapping function defined by multiple sub-functions, wherein each of the sub-functions applies to a different interval in a domain of the mapping function, and the step 204 and the step 205 of inputting the probability values of the candidate words into the mapping function, to obtain the probability mapping values corresponding to the candidate words comprise:
determining an interval that the probability values of the candidate words fall within, to acquire a corresponding sub-function as a specific mapping function applies to the interval; and
inputting the probability values of the candidate words into the specific mapping function, to obtain the probability mapping values corresponding to the candidate words, wherein the specific mapping function is configured for mapping the probability values on the interval into a specific range of the probability mapping values, wherein the specific range is a part of the whole range of the mapping function.

The mapping function ƒ(x) may map the probability values in the probability-values range [0,1] into the specified range of probability mapping values [1,W−1]. In an embodiment of the present disclosure, the specified range of probability mapping values is [1,W−1], which may be divided into 3 intervals, wherein [W_{E}, W−W_{E}] is the high-accuracy interval, and [1, W_{E}) and (W−W_{E}, W−1] are the low-accuracy intervals.

Preferably, the mapping function ƒ(x) according to the embodiments of the present disclosure may also map the probability values in a specific probability-values range into a specific range of probability mapping values. Particularly, the probability values in the specific probability-values range [0, A⁻¹·p₀) may be mapped into the specific range of probability mapping values (W−W_{E}, W−1], the probability values in the specific probability-values range [A⁻¹·p₀, A·p₀] may be mapped into the specific range of probability mapping values [W_{E}, W−W_{E}], and the probability values in the specific probability-values range (A·p₀, 1] may be mapped into the specific range of probability mapping values [1, W_{E}).

The mapping function ƒ(x) may be:

$$f ( x ) = \{ \begin{matrix}{G}_{0} + \frac{g ( x ) - {G}_{0}}{g ( 0 ) - {G}_{0}} \cdot ( W - 1 - {G}_{0} ) , 0 \leq x < {A}^{- 1} \cdot {p}_{0} \\ g ( x ) , {A}^{- 1} \cdot {p}_{0} \leq x \leq A \cdot {p}_{0} \\ {G}_{1} + \frac{g ( x ) - {G}_{1}}{g ( 1 ) - {G}_{1}} \cdot ( 1 - {G}_{1} ) , A \cdot {p}_{0} < x \leq 1\end{matrix}$$

$$wherein h ( x ) = ln ( x \cdot {K}^{{t}_{k}} + 1 ) , and g ( x ) = ( h ( {p}_{0} ) - h ( x ) ) \cdot L + \frac{W}{2} ,$$

$$L = \frac{W - 2 {W}_{E}}{2 \cdot ln ( A )} , {G}_{0} = g ( {A}^{- 1} \cdot {p}_{0} ) , {G}_{1} = g ( A \cdot {p}_{0} )$$

wherein tₖ is a dispersion exponent of a distribution of the probability mapping values, K is the sample-type quantity, A is the distribution width, p₀ is the distribution center, W is an upper bound of the specified range of probability mapping values, and W_{E} is the range boundary.

As examples, the formula of tₖ may have the following types:
1) Smooth Distribution

$${t}_{k} = \frac{\frac{W - 2}{2 L} + ln ( {p}_{0}^{- 1} )}{l n ( K )}$$

2) High-Accuracy Boundary

$${t}_{k} = \frac{ln ( A ) + ln ( {p}_{0}^{- 1} ) + D}{ln ( K )}$$

3) High-Accuracy All-Interval Boundary

$${t}_{k} = \frac{ln ( {p}_{min}^{- 1} ) + D}{ln ( K )}$$

wherein D is a precision adjustment parameter. The parameter D is preset, and may not be required to be specified externally.

The embodiments of the present disclosure may comprise according to the specific probability-values range that the probability values belong to, determining the corresponding sub-function, to map the probability values in the specific probability-values range into the specific range of probability mapping values.

Taking the above mapping function ƒ(x) as an example, assuming that the probability value is 1, then it belongs to the specific probability-values range (A·p₀, 1], and the corresponding sub-function (i.e., the specific mapping function) is:

$$f ( x ) = {G}_{1} + \frac{g ( x ) - {G}_{1}}{g ( 1 ) - {G}_{1}} \cdot ( 1 - {G}_{1} )$$

Therefore, the probability value 1 in the specific probability-values range (A·p₀, 1] may be inputted into the specific mapping function, thereby obtaining the probability mapping value 1 in the specific range of probability mapping values [1, W_{E}).

By using the embodiments of the present disclosure, regarding each of the probability values p, after mapped by the mapping function ƒ(x), one probability mapping value p′=ƒ (p) is obtained. Regarding each of the unique probability values p, one unique probability mapping value p′ corresponds to it, with a bijection. Each of the groups of the probability values p, after mapped by the mapping function, one group of probability mapping values p′ are obtained. Then, the group of numerical values are rounded, to obtain the quantized probability mapping values v of one group of probability mapping values of integer datatype. The group of integer values are the quantization result of the probability values that the embodiments of the present disclosure seek to solve.

The embodiments of the present disclosure may, according to the figure of distribution of the sample probability values of the candidate-word samples, use different mapping-function subfunctions, wherein the function In may be directly replaced with the function log, with a very close effect. Particularly: 1. If the sample probability values have a normal distribution after the In transformation, the function In (or function log) may be used, as the mapping-function subfunction; 2. If the sample probability values have a normal distribution after the exp transformation, the function exp may be used, as the mapping-function subfunction; and 3. If the sample probability values have a normal distribution after the tanh transformation, the function tanh may be used, as the mapping-function subfunction. For any other function, the mapping-function subfunction may be replaced by using the above method.

The first embodiment of the input method based on sample-probability quantization according to the present disclosure has been described above. A second embodiment of the input method based on sample-probability quantization according to the present disclosure will be described below.

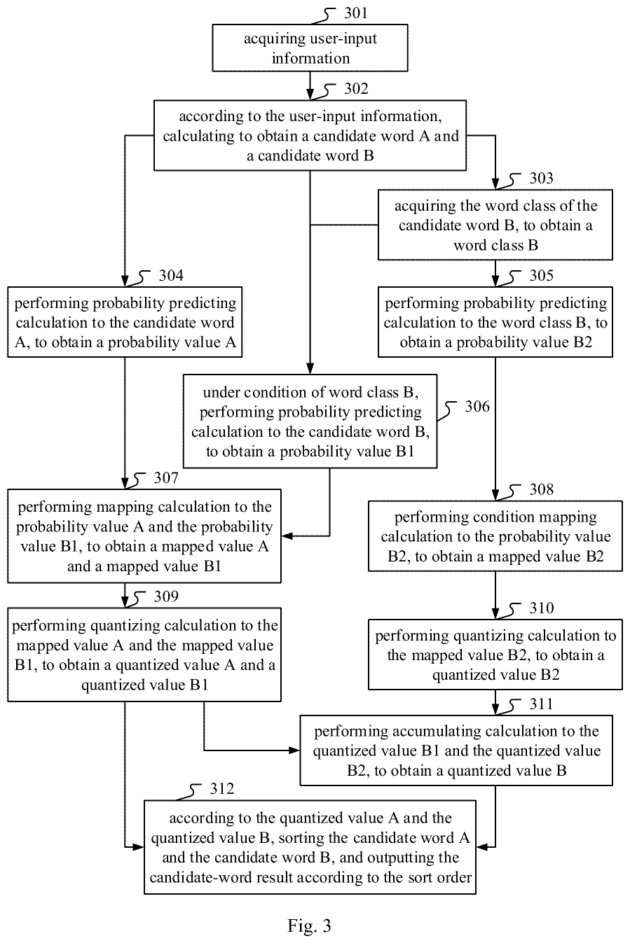

Referring to FIG. 3, FIG. 3 shows a flow chart of the steps of a second embodiment of the input method based on sample-probability quantization according to the present disclosure, which may particularly comprise the following steps:

Step 301: acquiring a user-input information.

It should be noted that the description on the step 301 is the same as the description on the step 201 in the first embodiment, which may particularly refer to the above description, and is not discussed here further.

Step 302: according to the user-input information, calculating to obtain candidate words.

It should be noted that the description on the step 302 is the same as the description on the step 202 in the first embodiment, which may particularly refer to the above description, and is not discussed here further.

Step 303: acquiring word classes of the candidate words.

The word classes of the candidate words are the identifiers for the classification of the candidate words, wherein the mode of the classification may be classification by lexical category, and may also be classification by initial letter. For example, both of the word z-axis and the word z-bar are words starting with z−, so the word z-axis and the word z-bar belong to the word class of z−. If a candidate word is an unfamiliar word, and cannot directly undergo the probability predicting calculation in a language model that has been trained in advance, then, it is required to firstly obtain the word class of the candidate word, and then input a word-class information into a language model, thereby indirectly performing the probability predicting calculation to the candidate word in the language model.

Step 304: performing probability predicting calculation to the candidate words, to obtain probability values of the candidate words.

If a candidate word is a commonly used word, and can directly undergo the probability predicting calculation in a language model that has been trained in advance, then the calculation may be performed without obtaining the word class.

It should be noted that the description on the step 304 is the same as the description on the step 203 in the first embodiment, which may particularly refer to the above description, and is not discussed here further.

Step 305: performing probability predicting calculation to the word classes of the candidate words, to obtain the probability-of-condition values of the word classes of the candidate words.

It should be noted that, in some language models, although unfamiliar candidate words cannot directly undergo the probability predicting calculation, the unfamiliar candidate words still may firstly be clustered, to obtain the word classes of the candidate words, and then the word classes of the candidate words may undergo the probability predicting calculation, to obtain the probability values of the word classes themselves of the candidate words, i.e., the probability-of-condition values of the word classes of the candidate words.

Step 306: under the condition of the word classes of the candidate words, performing probability predicting calculation to the candidate words, to obtain conditional-probability values of the candidate words.

It should be noted that, because the word classes of the candidate words have already been obtained in the above steps, unfamiliar candidate words can undergo probability predicting calculation under the condition of limited word classes. Under the condition of the word classes of a narrow range, a probability predicting method different from the above steps may be used, to perform probability predicting calculation to the candidate words, thereby obtaining the conditional-probability values of the candidate words.

Step 307: inputting the probability values or the conditional-probability values of the candidate words into the mapping function, to obtain probability mapping values or conditional-probability mapping values corresponding to the candidate words.

It should be noted that the description on the step 307 is the same as the description on the step 204 and the step 205 in the first embodiment, which may particularly refer to the above description, and is not discussed here further.

Step 308: inputting the probability-of-condition values of the word classes of the candidate words into the condition mapping function, to obtain probability-of-condition mapping values corresponding to the word classes.

The condition mapping function ƒₘ(m) is configured according to corpus samples of regions, electronic devices and other demand responses. The condition mapping function may be obtained from, for example, the condition-mapping-function generating method of the step 107, and may also be obtained from other condition-mapping-function generating methods.

Step 309: performing rounding processing to the probability mapping values or the conditional-probability mapping values, to obtain quantized probability mapping values or quantized conditional-probability mapping values.

Step 310: performing rounding processing to the probability-of-condition mapping values, to obtain quantized probability-of-condition mapping values.

The quantization function may be obtained from, for example, the quantization-function generating method of the step 108, and may also be obtained from other quantization-function generating methods.

It can be seen that the step 309 and the step 310 are two similar steps. Their function is that they group several probability mapping values, and separately perform quantizing calculation to the probability mapping values of each of the groups, wherein the quantizing calculation processes of each of the groups may be independent and asynchronous. The quantized probability mapping values obtained after the quantizing calculation of each of the groups may be summarized to the next step for collective processing. That means that, no matter how the probability mapping values are grouped, and no matter how the order between the quantizing calculations of each of the groups is determined, the result of the quantized probability mapping values obtained by quantizing calculation is not changed. That provides support for the high concurrency of the process of quantizing calculation.

Step 311: performing accumulating calculation to the quantized conditional-probability mapping values with the corresponding quantized probability-of-condition mapping values, to obtain quantized probability mapping values.

The conditional-probability mapping values and the corresponding probability-of-condition mapping values may firstly undergo accumulating calculation and then undergo rounding processing, and may also firstly undergo rounding processing individually and then undergo accumulating calculation. The quantized probability mapping values obtained by the two modes are slightly different, with a small error range. The embodiments of the present disclosure employ the mode of firstly performing rounding processing individually and then performing accumulating calculation, whose advantage is that the calculating and processing unit of the probability-of-condition values may be integrated into another separate module, which reduces the coupling degree between the modules, and improve the capacity of concurrency of the calculation.

Step 312: according to the quantized probability mapping values, determining an order of the candidate words, to output a list of candidate words in order.

It should be noted that the description on the step 312 is the same as the description on the step 207 in the first embodiment, which may particularly refer to the above description, and is not discussed here further.

In an exemplary embodiment, in the step 308, the probability-of-condition values of the word classes of the candidate words are inputted into the condition mapping function, to obtain probability-of-condition mapping values corresponding to the word classes. The embodiments of the present disclosure, according to demands of operation, define the condition mapping function ƒₘ.

The condition mapping function ƒₘ(m) may be:

ƒₘ(m)=ln(m⁻¹)·L

wherein m is the probability-of-condition value.

In an embodiments of the present disclosure, for any p∈[A⁻¹·p₀, A·p₀], m∈R⁺, if p·m∈[A⁻¹·p₀, A·p₀], then

ƒ(p·m)≈ƒ(p)+ƒₘ(m)

Particularly, the function of the condition mapping function ƒₘ according to the embodiments of the present disclosure is mapping the rule of multiplication of the probability values in the conditional-probability formula into the rule of addition of the probability mapping values in the conditional-probability mapping formula, and mapping the relation of multiplication of the probability value domain into the relation of addition of the probability mapping value domain. Regarding the conditional-probability coefficient m of each of the conditional-probability values p, i.e., the probability-of-condition values m, after mapped by the condition mapping function ƒₘ, the probability-of-condition mapping value m′=ƒₘ(m) of the conditional-probability mapping value p′ is obtained.

When the probability predicting calculation cannot be directly performed to the candidate words, the process may comprise indirectly performing probability predicting calculation, to obtain the conditional-probability values p and the probability-of-condition values m corresponding to the candidate words, then performing mapping calculation to their probability values individually, to obtain the conditional-probability mapping values p′ and the probability-of-condition mapping values m′, and then adding the two mapped values, to obtain new probability mapping values The result is equivalent to the result of directly performing mapping calculation to the probability values p·m under the condition of total probability, i.e., ƒ(p·m)≈ƒ(p)+ƒₘ(m)=p′+m′.

In conclusion, it can be known that the embodiments of the present disclosure have at least the following advantages:

1. The embodiments of the present disclosure can, according to the figure of distribution of the probability values, map the probability values in the specific probability-values range [a, b] into the specific probability-mapping-values range [c, d].

2. The embodiments of the present disclosure can, according to the figure of distribution of the probability mapping values, adjust the statistical dispersion (standard deviation) of the probability mapping values by using the parameters.

3. The probability values and the probability mapping values are bijective, so the probability mapping values of different groups are comparable and sortable. Therefore, even if the data of the results of the different groups are combined and are arranged in order according to the probability mapping values, the result is equivalent to the ordered arrangement according to the probability values, which enables the sorting results before and after the quantization of the probability values to maintain consistent to the largest extent.

In order to better understand the embodiments of the present disclosure, the present disclosure will be described below by using particular examples.

Example 1: It is assumed that the input samples are one, two, two, three, three and three, as totally 6 times of inputting, which generates 3 sample types, namely one, two and three. The sample probability value of the one is 1/6, the sample probability value of the two is 2/6, and the sample probability value of the three is 3/6. If the predicted words are to be sorted according to the magnitudes of the probability values, the order sequence is three, two and one. Now, because of the problem in the storage space of an electronic device, the probability values are required to be quantized, wherein the target interval of the quantization is [0,3].

1) If an un-well-defined mapping function (for example, tanh) is employed, the sample probability values of one, two and three might be mapped into 2, 1 and 1, and if the predicted words are to be sorted according to the quantized values obtained after mapping, the order might be two, three and one, which order is different from the order of sorting according to the probability values.

2) If a well-defined mapping function (for example, the target mapping function according to the embodiments of the present disclosure) is employed, the sample probability values of one, two and three might be mapped into 3, 2 and 1, and if the predicted words are to be sorted according to the quantized values obtained after mapping, the order is three, two and one, which order is the same as the order of sorting according to the probability values.

The mapping function according to the embodiments of the present disclosure can adjust the statistical dispersion of the probability mapping values, wherein if the statistical dispersion of the distribution of the quantized values obtained after the mapping in the target interval is higher, then the degree of distortion of the quantized values is lower, and the sorting after the quantization has a higher similarity with the original sorting.

Example 2: Regarding grouped quantization, the cases are more complicated. For example, the input samples are one, two, two, three, three, three, four, four, four and four, as totally times of inputting, which generates 4 sample types, namely one, two, three and four. The sample probability value of the one is 1/10, the sample probability value of the two is 2/10, the sample probability value of the three is 3/10, and the sample probability value of the four is 4/10. If the predicted words are to be sorted according to the magnitudes of the probability values, the order is four, three, two and one. Now, because of the problem in the storage space, the probability values are required to be quantized, wherein the target interval of the quantization is [0,3].

1) If an un-well-defined mapping function (for example, min-max) is employed, the first group is one and two, whose quantized values obtained after mapping might be 2 and 1, and the second group is three and four, whose quantized values obtained after mapping might be 2 and 1. After the results of the first group and the second group have been combined, if the predicted words are to be sorted according to the quantized values obtained after mapping, the order might be two, four, one and three, which order is different from the order of sorting according to the probability values.

2) If a well-defined mapping function (for example, the embodiments of the present disclosure) is employed, the first group is one and two, whose quantized values obtained after mapping might be 3 and 2, and the second group is three and four, whose quantized values obtained after mapping might be 1 and 0. After the results of the first group and the second group have been combined, if the predicted words are to be sorted according to the quantized values obtained after mapping, the order is four, three, two and one, which order is the same as the order of sorting according to the probability values.

In particular applications, if the sorting of the predicted words before and after the quantization of the probability values are different, that affects the Word Prediction Rate and the Keystroke Savings Rate. However, because the embodiments of the present disclosure employ the well-defined mapping function, the sorting of the predicted words before and after the quantization is changed slightly or even maintains unchanged. Therefore, the embodiments of the present disclosure can increase the two parameters to a certain extent, to increase the accuracy of word prediction.

It should be noted that, regarding the process embodiments, for brevity of the description, all of them are expressed as the combination of a series of actions, but a person skilled in the art should know that the embodiments of the present disclosure are not limited by the sequences of the actions that are described, because, according to the embodiments of the present disclosure, some of the steps may have other sequences or be performed simultaneously. Secondly, a person skilled in the art should also know that all of the embodiments described in the description are preferable embodiments, and not all of the actions that they involve are required by the embodiments of the present disclosure.

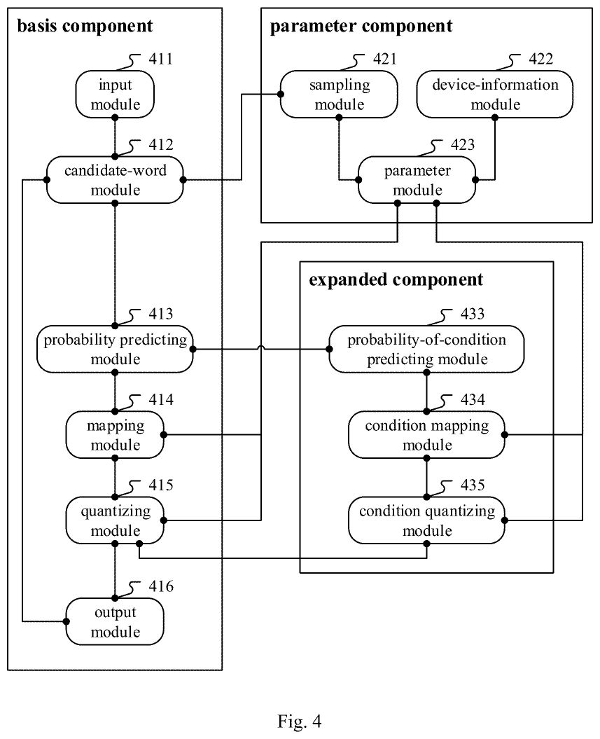

Referring to FIG. 4, FIG. 4 shows a structural block diagram of an embodiment of the input apparatus based on sample-probability quantization according to the present disclosure, which may particularly comprise the following modules:
an input module 411 configured for acquiring a user-input information;
a candidate-word module 412 configured for, according to the user-input information, calculating to obtain candidate words;
a probability predicting module 413 configured for performing probability predicting calculation to the candidate words, to obtain probability values of the candidate words;
a mapping module 414 configured for inputting the probability values of the candidate words into a mapping function, to obtain probability mapping values corresponding to the candidate words, wherein the mapping function is configured for mapping the probability values into a specified range of probability mapping values, and within the specified range, adjusting a statistical dispersion of the probability mapping values into an expectation, wherein the probability values and the probability mapping values are bijective;
a quantizing module 415 configured for performing rounding processing to the probability mapping values, to obtain quantized probability mapping values; and
an output module 416 configured for, according to the quantized probability mapping values, determining an order of the candidate words, to output a list of candidate words in order.

The above modules may form a basic component of the apparatus, which is configured for realizing basic functions of the input method. When a complicated problem requires to be solved, those basic modules may also be adaptively adjusted in function.

In an optional embodiment, the apparatus may further comprise the following modules:
a sampling module 421 configured for collecting and summarizing candidate-word sample data;
a device-information module 422 configured for acquiring a data-storage-space information of an electronic device; and
a parameter module 423 configured for, according to the candidate-word sample data, and the data-storage-space information of the electronic device, calculating to obtain a sample-type quantity, a distribution width, a distribution center, a specified range of probability mapping values and a range boundary, and generating a mapping function, a condition mapping function and a quantization function.

The above modules may form a parameter component of the apparatus, which is configured for generating relevant contents such as the mapping function. Before the application of the input-method program, the pre-processing process uses those parameter modules to calculate the corpus data. In the updating of the input-method program, the iteration process uses those parameter modules to repeatedly calculate the updated corpus data.

In an optional embodiment, the mapping function comprises a piecewise mapping function defined by multiple sub-functions, wherein each of the sub-functions applies to a different interval in a domain of the mapping function, the mapping module 414 is configured for determining an interval that the probability values of the candidate words fall within, to acquire a corresponding sub-function as a specific mapping function applies to the interval; and inputting the probability values of the candidate words into the specific mapping function, to obtain the probability mapping values corresponding to the candidate words, wherein the specific mapping function is configured for mapping the probability values on the interval into a specific range of the probability mapping values, wherein the specific range is a part of the whole range of the mapping function.

In an optional embodiment, the apparatus may further comprise the following modules:
a probability predicting module 413 configured for acquiring word classes corresponding to the candidate words, and under a condition of the word classes, performing probability predicting calculation to the candidate words, to obtain conditional-probability values of the candidate words;
a probability-of-condition predicting module 433 configured for performing probability predicting calculation to the word classes, to obtain probability-of-condition values of the word classes;
a mapping module 414 configured for inputting the conditional-probability values of the candidate words into the mapping function, to obtain conditional-probability mapping values corresponding to the candidate words, wherein the mapping function is configured for mapping the conditional-probability values into a specified range of probability mapping values, and within the specified range, adjusting the statistical dispersion of the conditional-probability mapping values into an expectation, wherein the conditional-probability values and the conditional-probability mapping values are bijective;
a condition mapping module 434 configured for inputting the probability-of-condition values of the word classes into the condition mapping function, to obtain probability-of-condition mapping values corresponding to the word classes;
a condition quantizing module 435 configured for performing rounding processing to the probability-of-condition mapping values, to obtain quantized probability-of-condition mapping values; and
a quantizing module 415 configured for firstly performing accumulating calculation and then performing rounding processing to the probability-of-condition mapping values and the conditional-probability mapping values, or firstly performing rounding processing to the conditional-probability mapping values and then performing accumulating calculation with the quantized probability-of-condition mapping values, to obtain the quantized probability mapping values of the candidate words.

The above modules may form an expanded component of the apparatus, which, when the probability predicting calculation cannot be directly performed to the candidate words, may, by using the method of conditional probability, indirectly perform probability predicting calculation to the candidate words. Its effect is equivalent to obtaining the result of the probability values of the candidate words under the condition of total probability. In order to realize the above object, some of the modules of the basic component have been adaptively adjusted in function.

In an optional embodiment, the mapping function ƒ(x) is:

$$f ( x ) = \{ \begin{matrix}{G}_{0} + \frac{g ( x ) - {G}_{0}}{g ( 0 ) - {G}_{0}} \cdot ( W - 1 - {G}_{0} ) , 0 \leq x < {A}^{- 1} \cdot {p}_{0} \\ g ( x ) , {A}^{- 1} \cdot {p}_{0} \leq x \leq A \cdot {p}_{0} \\ {G}_{1} + \frac{g ( x ) - {G}_{1}}{g ( 1 ) - {G}_{1}} \cdot ( 1 - {G}_{1} ) , A \cdot {p}_{0} < x \leq 1\end{matrix}$$

$$wherein h ( x ) = ln ( x \cdot {K}^{{t}_{k}} + 1 ) , and g ( x ) = ( h ( {p}_{0} ) - h ( x ) ) \cdot L + \frac{W}{2} ,$$

$$L = \frac{W - 2 {W}_{E}}{2 \cdot ln ( A )} , {G}_{0} = g ( {A}^{- 1} \cdot {p}_{0} ) , {G}_{1} = g ( A \cdot {p}_{0} )$$

wherein tₖ is a dispersion exponent of a distribution of the probability mapping values, K is the sample-type quantity, A is the distribution width, p₀ is the distribution center, W is an upper bound of the specified range of probability mapping values, and W_{E} is the range boundary; wherein a formula of tₖ is one of:

$${t}_{k} = \frac{\frac{W - 2}{2 L} + ln ( {p}_{0}^{- 1} )}{l n ( K )}$$

$${t}_{k} = \frac{ln ( A ) + ln ( {p}_{0}^{- 1} ) + D}{ln ( K )}$$

$${t}_{k} = \frac{ln ( {p}_{min}^{- 1} ) + D}{ln ( K )}$$

wherein D is a precision adjustment parameter.

In an optional embodiment, the condition mapping function ƒₘ(m) is:

ƒₘ(m)=ln(m⁻¹)·L

wherein m is the probability-of-condition value.

In conclusion, the embodiments of the present disclosure acquire a user-input information, calculate to obtain candidate words, perform probability predicting calculation to the candidate words, to obtain the probability values of the candidate words, then input the probability values of the candidate words into a mapping function, to obtain probability mapping values corresponding to the candidate words, then perform rounding processing to the probability mapping values, to obtain quantized probability mapping values, then according to the quantized probability mapping values, determine the order of the candidate words, and finally output a list of candidate words in order. The embodiments of the present disclosure, by using the mapping function, can map the probability values into the specified range of probability mapping values, and, by using the mapping function, can adjust the statistical dispersion of the probability mapping values into an expectation, which can reduce the degree of distortion of the probability values after the quantization to the largest extent, which enables the order of the list of candidate words determined based on the probability values after the quantization to maintain consistent with that before the quantization to the largest extent. In addition, by using the mapping function, the probability values and the probability mapping values can be bijective, and, because even probability mapping values obtained by calculation from different electronic devices are based on the same one mapping method, the different probability mapping values are comparable and sortable, which enables the method of the candidate words recommendation to be generalized and standardized, thereby facilitating subsequent development and expansion.

Regarding the device embodiments, because they are substantially similar to the process embodiments, they are described simply, and the related parts may refer to the description on the process embodiments.

The embodiments of the description are described in the mode of progression, each of the embodiments emphatically describes the differences from the other embodiments, and the same or similar parts of the embodiments may refer to each other.

A person skilled in the art should understand that the embodiments of the present disclosure may be provided as a method, a device, or a computer program product. Therefore, the embodiments of the present disclosure may take the form of a complete hardware embodiment, a complete software embodiment, or an embodiment combining software and hardware. Furthermore, the embodiments of the present disclosure may take the form of a computer program product implemented on one or more computer-usable storage media (including but not limited to a disk storage, a CD-ROM, an optical memory and so on) containing a computer-usable program code therein.

The embodiments of the present disclosure are described with reference to the flow charts and/or block diagrams of the method, the electronic device (system), and the computer program product according to the embodiments of the present disclosure. It should be understood that each flow and/or block in the flow charts and/or block diagrams, and combinations of the flows and/or blocks in the flow charts and/or block diagrams, may be implemented by a computer program instruction. The computer program instructions may be provided to a processor of a general-purpose computer, a special-purpose computer, an embedded processor, or another programmable data processing electronic device to generate a machine, so that a device for implementing the functions specified in one or more flows of the flow charts and/or one or more blocks of the block diagrams can be generated by instructions executed by the processor of the computers or the other programmable data processing electronic device.

The computer program instructions may also be stored in a computer-readable memory that can instruct the computers or the other programmable data processing electronic device to operate in a specific mode, so that the instructions stored in the computer-readable memory generate an article comprising an instruction device, and the instruction device implements the functions specified in one or more flows of the flow charts and/or one or more blocks of the block diagrams.

The computer program instructions may also be loaded to the computers or the other programmable data processing electronic device, so that the computers or the other programmable data processing electronic device implement a series of operation steps to generate the computer-implemented processes, whereby the instructions executed in the computers or the other programmable data processing electronic device provide the steps for implementing the functions specified in one or more flows of the flow charts and/or one or more blocks of the block diagrams.

Although preferable embodiments of the embodiments of the present disclosure have been described, once a person skilled in the art has known the essential inventive concept, he may make further variations and modifications on those embodiments. Therefore, the appended claims are intended to be interpreted as including the preferable embodiments and all of the variations and modifications that fall within the scope of the embodiments of the present disclosure.

Finally, it should also be noted that, in the present text, relation terms such as first and second are merely intended to distinguish one entity or operation from another entity or operation, and that does not necessarily require or imply that those entities or operations have therebetween any such actual relation or order. Furthermore, the terms “include”, “comprise” or any variants thereof are intended to cover non-exclusive inclusions, so that processes, methods, articles or electronic devices that include a series of elements do not only include those elements, but also include other elements that are not explicitly listed, or include the elements that are inherent to such processes, methods, articles or electronic devices. Unless further limitation is set forth, an element defined by the wording “comprising a . . . ” does not exclude additional same element in the process, method, article or electronic device comprising the element.

The input method and apparatus according to the present disclosure have been described in detail above. The principle and the embodiments of the present disclosure are described herein with reference to the particular examples, and the description of the above embodiments is merely intended to facilitate to understand the method according to the present disclosure and its core concept. Moreover, for a person skilled in the art, according to the concept of the present disclosure, the particular embodiments and the range of application may be varied. In conclusion, the contents of the description should not be understood as limiting the present disclosure.

1. An input method based on sample-probability quantization, wherein
the method comprises:
acquiring a user-input information, and calculating to obtain candidate words;
performing probability predicting calculation to the candidate words, to obtain probability values of the candidate words;
inputting the probability values of the candidate words into a mapping function, to obtain probability mapping values corresponding to the candidate words, wherein the mapping function is configured for mapping the probability values into a specified range of probability mapping values, and within the specified range, adjusting a statistical dispersion of the probability mapping values into an expectation, wherein the probability values and the probability mapping values are bijective;
performing rounding processing to the probability mapping values, to obtain quantized probability mapping values; and
according to the quantized probability mapping values, determining an order of the candidate words, to output a list of candidate words in order;
wherein the mapping function comprises a piecewise mapping function defined by multiple sub-functions, wherein each of the sub-functions applies to a different interval in a domain of the mapping function, and the step of inputting the probability values of the candidate words into the mapping function, to obtain the probability mapping values corresponding to the candidate words comprises:
determining an interval that the probability values of the candidate words fall within, to acquire a corresponding sub-function as a specific mapping function applies to the interval; and
inputting the probability values of the candidate words into the specific mapping function, to obtain the probability mapping values corresponding to the candidate words, wherein the specific mapping function is configured for mapping the probability values on the interval into a specific range of the probability mapping values, wherein the specific range is a part of the whole range of the mapping function.

2. The method according to claim 1, wherein before the step of performing probability predicting calculation to the candidate words, to obtain the probability values of the candidate words, the method further comprises:
collecting and summarizing candidate-word sample data, and counting up to obtain a sample-type quantity of candidate-word samples;
performing statistical analysis to the candidate-word samples, to obtain sample probability values of the candidate-word samples, and then, according to a figure of distribution of the sample probability values, calculating to obtain a distribution width and a distribution center;
acquiring a data-storage-space information of an electronic device, and calculating to obtain the specified range of probability mapping values and a range boundary; and
according to the sample-type quantity, the distribution width, the distribution center, the specified range of probability mapping values and the range boundary, generating the mapping function and a quantization function.

3. The method according to claim 2, wherein the method further comprises:
according to the distribution width, the specified range of probability mapping values and the range boundary, generating a condition mapping function.

4. (canceled)

5. The method according to claim 3, wherein the method further comprises:
acquiring word classes corresponding to the candidate words;
performing probability predicting calculation to the word classes, to obtain probability-of-condition values of the word classes;
under a condition of the word classes, performing probability predicting calculation to the candidate words, to obtain conditional-probability values of the candidate words;
inputting the probability-of-condition values of the word classes into the condition mapping function, to obtain probability-of-condition mapping values corresponding to the word classes;
inputting the conditional-probability values of the candidate words into the mapping function, to obtain conditional-probability mapping values corresponding to the candidate words; and
firstly performing accumulating calculation and then performing rounding processing, or firstly performing rounding processing and then performing accumulating calculation, to the probability-of-condition mapping values and the conditional-probability mapping values, to obtain the quantized probability mapping values of the candidate words.

6. The method according to claim 2, wherein the mapping function ƒ(x) is:
$$f ( x ) = \{ \begin{matrix}{G}_{0} + \frac{g ( x ) - {G}_{0}}{g ( 0 ) - {G}_{0}} \cdot ( W - 1 - {G}_{0} ) , 0 \leq x < {A}^{- 1} \cdot {p}_{0} \\ g ( x ) , {A}^{- 1} \cdot {p}_{0} \leq x \leq A \cdot {p}_{0} \\ {G}_{1} + \frac{g ( x ) - {G}_{1}}{g ( 1 ) - {G}_{1}} \cdot ( 1 - {G}_{1} ) , A \cdot {p}_{0} < x \leq 1\end{matrix}$$
$$wherein h ( x ) = ln ( x \cdot {K}^{{t}_{k}} + 1 ) , and g ( x ) = ( h ( {p}_{0} ) - h ( x ) ) \cdot L + \frac{W}{2} ,$$
$$L = \frac{W - 2 {W}_{E}}{2 \cdot ln ( A )} , {G}_{0} = g ( {A}^{- 1} \cdot {p}_{0} ) , {G}_{1} = g ( A \cdot {p}_{0} )$$
wherein tₖ is a dispersion exponent of a distribution of the probability mapping values, K is the sample-type quantity, A is the distribution width, p₀ is the distribution center, W is an upper bound of the specified range of probability mapping values, and W_{E} is the range boundary;
wherein a formula of tₖ is one of:
$${t}_{k} = \frac{\frac{W - 2}{2 L} + ln ( {p}_{0}^{- 1} )}{l n ( K )}$$
$${t}_{k} = \frac{ln ( A ) + ln ( {p}_{0}^{- 1} ) + D}{ln ( K )}$$
$${t}_{k} = \frac{ln ( {p}_{min}^{- 1} ) + D}{ln ( K )}$$
wherein D is a precision adjustment parameter.

7. The method according to claim 5, wherein the condition mapping function ƒₘ(m) is:
ƒₘ(m)=ln(m₋₁)·L
wherein m is the probability-of-condition value.

8. An input apparatus based on sample-probability quantization, wherein the apparatus comprises:
an input module configured for acquiring a user-input information;
a candidate-word module configured for, according to the user-input information, calculating to obtain candidate words;
a sampling module configured for collecting and summarizing candidate-word sample data;
a device-information module configured for acquiring a data-storage-space information of an electronic device;
a parameter module configured for, according to the candidate-word sample data, and the data-storage-space information of the electronic device, calculating to obtain a sample-type quantity, a distribution width, a distribution center, a specified range of probability mapping values and a range boundary, and generating a mapping function, a condition mapping function and a quantization function;
a probability predicting module configured for performing probability predicting calculation to the candidate words, to obtain probability values of the candidate words; and further configured for acquiring word classes corresponding to the candidate words, and under a condition of the word classes, performing probability predicting calculation to the candidate words, to obtain conditional-probability values of the candidate words;
a probability-of-condition predicting module configured for performing probability predicting calculation to the word classes, to obtain probability-of-condition values of the word classes;
a mapping module configured for inputting the probability values or the conditional-probability values of the candidate words into the mapping function, to obtain probability mapping values or conditional-probability mapping values corresponding to the candidate words, wherein the mapping function is configured for mapping the probability values or the conditional-probability values into a specified range of probability mapping values, and within the specified range, adjusting a statistical dispersion of the probability mapping values or the conditional-probability mapping values into an expectation, wherein the probability values and the probability mapping values are bijective, and the conditional-probability values and the conditional-probability mapping values are bijective;
a condition mapping module configured for inputting the probability-of-condition values of the word classes into the condition mapping function, to obtain probability-of-condition mapping values corresponding to the word classes;
a condition quantizing module configured for performing rounding processing to the probability-of-condition mapping values, to obtain quantized probability-of-condition mapping values;
a quantizing module configured for performing rounding processing to the probability mapping values, to obtain quantized probability mapping values; and further configured for firstly performing accumulating calculation and then performing rounding processing to the probability-of-condition mapping values and the conditional-probability mapping values, or firstly performing rounding processing to the conditional-probability mapping values and then performing accumulating calculation with the quantized probability-of-condition mapping values, to obtain the quantized probability mapping values of the candidate words; and
an output module configured for, according to the quantized probability mapping values, determining an order of the candidate words, to output a list of candidate words in order;
wherein the mapping function comprises a piecewise mapping function defined by multiple sub-functions, wherein each of the sub-functions applies to a different interval in a domain of the mapping function, and the mapping module is configured for:
determining an interval that the probability values of the candidate words fall within, to acquire a corresponding sub-function as a specific mapping function applies to the interval; and
inputting the probability values of the candidate words into the specific mapping function, to obtain the probability mapping values corresponding to the candidate words, wherein the specific mapping function is configured for mapping the probability values on the interval into a specific range of the probability mapping values, wherein the specific range is a part of the whole range of the mapping function.

9. An electronic device, wherein the electronic device comprises a memory, and one or more programs, wherein the one or more programs are stored in the memory, and the one or more programs are configured for being executed by one or more processors to implement the input method based on sample-probability quantization according to claim 1.

10. A non-transitory computer-readable storage medium, wherein when an instruction in the storage medium is executed by a processor of an electronic device, the electronic device is able to implement the input method based on sample-probability quantization according to claim 1.
